(19) United States
(12) Patent Application Publication
(10) Pub. No.: US 2025/0051159 A1
(43) Pub. Date: Feb. 13, 2025

(54) PROCESS FOR PRODUCING HYDROGEN AND METHOD OF RETROFITTING A HYDROGEN PRODUCTION UNIT

(71) Applicant: Johnson Matthey Public Limited Company, London (GB)

(72) Inventors: Kendra BRIGGS, Oakbrook Terrace, IL (US); Robert CHRISTIE, London (GB); Andrew JOHNSON, Billingham (GB); Mark Andrew LINTHWAITE, Billingham (GB); John David PACH, Billingham (GB); Heather SMITH, Stockton-on-Tees (GB)

(21) Appl. No.: 18/719,581

(22) PCT Filed: Mar. 6, 2023
(86) PCT No.: PCT/GB2023/050517

§ 371 Date: Jun. 13, 2024

Related U.S. Application Data
(60) Provisional application No. 63/269,195, filed on Mar. 11, 2022.

(30) Foreign Application Priority Data
Mar. 23, 2022 (GB) 2204042.2

(51) Int. Cl. C01B 3/38; B01D 53/04; B01D 53/047; B01D 53/14; B01D 53/18; B01D 53/62; B01D 53/77; C01B 3/48

(52) U.S. Cl. CPC C01B 3/382; B01D 53/0462; B01D 53/047; B01D 53/1475; B01D 53/1493; B01D 53/18; B01D 53/62; B01D 53/77; C01B 3/48; B01D 2252/204; B01D 2256/16; B01D 2257/504; C01B 2203/0233; C01B 2203/0244; C01B 2203/0283; C01B 2203/0415; C01B 2203/043; C01B 2203/0475; C01B 2203/0822; C01B 2203/0827; C01B 2203/1241

(57) ABSTRACT

A plant for the production of hydrogen, comprising: a fired reformer containing a plurality of catalyst-containing reformer tubes and having a shell side, operable to produce a crude synthesis gas from a feed stream containing a hydrocarbon and steam; an autothermal reformer arranged to be fed with an oxygen-containing gas and a crude synthesis gas from the fired reformer, operable to produce a reformed synthesis gas; a water-gas shift unit arranged to be fed with a reformed synthesis gas recovered from the autothermal reformer, operable to produce a hydrogen-enriched gas; a carbon dioxide removal unit arranged to be fed with a hydrogen-enriched gas from the water-gas shift unit, operable to produce a crude hydrogen stream and a carbon dioxide stream; a purification unit arranged to be fed with a crude hydrogen stream gas from the carbon dioxide removal unit, operable to produce a hydrogen product stream and an off-gas stream.

### TECHNICAL FIELD

This invention relates a process for producing hydrogen from a hydrocarbon feedstock by steam reforming. An existing hydrogen production unit can be retrofitted to carry out the process, enabling carbon dioxide emissions associated with the process to be reduced.

### BACKGROUND TO THE INVENTION

Hydrogen is conventionally produced from hydrocarbon feedstocks by steam reforming in large-scale fired steam reformers that generate carbon dioxide-containing flue gases at low pressure. The large volume and low pressure of the flue gasses makes efficient capture of the carbon dioxide (CO₂) difficult. There is therefore a need for methods to adapt existing processes or provide new processes to reduce their carbon dioxide emissions and/or improve the efficiency of carbon capture from the process.

An example of a conventional hydrogen plant is described at [0002]-[0004] of WO2011/046680 (Praxair Technology). The plant comprises a steam methane reformer, water-gas shift unit and pressure-swing adsorption unit. The role of the steam methane reformer is to react a hydrocarbon feed with steam to produce hydrogen, carbon dioxide and carbon monoxide (a mixture commonly referred to as “synthesis gas” or “syngas”). The role of the water-gas shift unit is to react CO and steam in the feed to generate a shifted stream which is enriched in CO₂ and hydrogen by the water-gas shift reaction (1):

CO+H₂O→H₂+CO₂ (1)

The role of the pressure-swing adsorption unit is to separate hydrogen from the shifted stream and thereby produce a hydrogen product stream and a tail gas stream.

WO2011/046680 discloses a method and apparatus for producing hydrogen in which hydrocarbon containing feed gas streams are reacted in a steam methane reformer of an existing hydrogen plant and a catalytic reactor that reacts hydrocarbons, oxygen and steam. The catalytic reactor is a retrofit to the existing hydrogen plant to increase hydrogen production. The synthesis gas stream from the catalytic reactor which has been retrofit into the existing hydrogen plant has a methane slip of at least 2.0 dry mol %, a hydrogen to carbon monoxide ratio of at least 4.0 on a molar basis and a temperature of no greater than about 870° C. The resulting synthesis gas streams are combined, cooled, subjected to water-gas shift and then introduced into a production apparatus that can be a pressure swing adsorption unit. The amount of synthesis gas contained in a shifted stream made available to the production apparatus is increased by virtue of the combination of the synthesis gas streams to increase production of the hydrogen containing product. The catalytic reactor is operated such that the synthesis gas stream produced by such reactor is similar to that produced by the steam methane reformer and at a temperature that will reduce oxygen consumption within the catalytic reactor. This retrofitting method may increase hydrogen production but does not provide for reduced carbon dioxide emissions and more efficient carbon capture because carbon dioxide is still emitted through burning fuel to drive the endothermic steam reforming reaction.

US2010/199682 A1 (Institute Francais Du Petrole) describes a process for the production of hydrogen from a hydrocarbon feedstock and water vapour comprising in sequence: a stage in which a portion of the hydrocarbon feedstock is sent to a vapor-reforming unit and another portion of the hydrocarbon feedstock is send directly to an autothermal reformer in a mixture with the effluent from the vapor-reforming unit; a vapor conversion stage; and a carbon dioxide recovery stage. The heat that is necessary for steam reforming reactions in the vapor-reforming unit is provided by burning a fuel stream, such as natural gas, and therefore this process is still associated with significant carbon dioxide emissions.

US2011/0073809 (Air Liquide) describes a steam reforming process in which a portion of the hydrogen generated from reforming reactions is mixed with the hydrocarbon fuel fed the reformer for combustion. This reduces the carbon dioxide emissions of the process compared to when the fuel to the reformer is purely a hydrocarbon. The hydrogen recycle stream is taken from the crude syngas stream from the reformer, but there are no details of how the separated syngas is treated to achieve high hydrogen yield.

There is a need for further steam reforming processes having high hydrogen yields and low carbon dioxide emissions. The present invention addresses this problem.

### SUMMARY OF THE INVENTION

As discussed above, a conventional hydrogen plant typically comprises a fired reformer (also known as a steam methane reformer), a water-gas shift unit and a purification unit. The present inventors have found that the carbon emissions of the process can be reduced by: including an autothermal reformer between the fired reformer and the water-gas shift unit; including a carbon dioxide removal unit between the water-gas shift unit and the purification unit; and feeding some of the crude hydrogen stream from the carbon dioxide removal unit and/or some of the hydrogen product stream from the purification unit as fuel to the shell-side of the fired reformer. The inclusion of an autothermal reformer increases the hydrogen yield sufficiently so that the fired reformer can be heated by burning hydrogen rather than a hydrocarbon, thereby reducing or avoiding carbon dioxide emissions. The inclusion of an autothermal reformer also enables the production of high-pressure steam suitable for power generation, such that the overall power demands of the process may be reduced. Moreover, the requirement for fired heaters to generate steam or pre-heat feeds may be removed.

In a first aspect the invention relates to a plant for the production of hydrogen, comprising:
a fired reformer containing a plurality of catalyst-containing reformer tubes and having a shell side to which fuel is fed, operable to produce a crude synthesis gas from a feed stream containing a hydrocarbon and steam;
an autothermal reformer arranged to be fed with an oxygen-containing gas and a crude synthesis gas from the fired reformer, operable to produce a reformed synthesis gas;
a water-gas shift unit arranged to be fed with a reformed synthesis gas recovered from the autothermal reformer, operable to produce a hydrogen-enriched gas;
a carbon dioxide removal unit arranged to be fed with a hydrogen-enriched gas from the water-gas shift unit, operable to produce a crude hydrogen stream and a carbon dioxide stream;
a purification unit arranged to be fed with a crude hydrogen stream gas from the carbon dioxide removal unit, operable to produce a hydrogen product stream and an off-gas stream;
wherein the plant is arranged such that a portion of the crude hydrogen stream from the carbon dioxide removal unit and/or a portion of hydrogen product stream from the purification unit is fed as fuel to a shell-side of the fired reformer.

The hydrogen plant differs from known hydrogen plants in several important ways.

Firstly, an autothermal reformer is provided downstream from the fired reformer and upstream from the water-gas shift unit. The fired reformer and autothermal reformer are arranged in series, i.e. part or all of the crude synthesis gas from the fired reformer is used as the feed to the autothermal reformer. The inclusion of an autothermal reformer between the fired reformer and water-gas shift unit achieves a greater methane conversion than a comparable arrangement without the autothermal reformer. The additional hydrogen produced can be used as fuel for the fired reformer (as described below) which reduces the carbon dioxide emissions from the process. The high temperature of the reformed synthesis gas produced by the autothermal reformer allow the generation of high pressure steam which can be used elsewhere in the process, thereby improving the energy efficiency of the process overall.

Secondly, a carbon dioxide removal unit is provided downstream from the water-gas shift unit and upstream from the hydrogen purification unit. The role of the carbon dioxide removal unit is to separate the hydrogen-enriched gas coming from the water-gas shift unit into a crude hydrogen stream and a carbon dioxide stream. The carbon dioxide can be captured and removed from the process by known techniques. The incorporation of a carbon dioxide removal unit means that carbon dioxide produced by the reforming and water-gas shift reactions is not vented to the atmosphere.

In a conventional hydrogen plant a hydrocarbon fuel is fed to the shell side of fired reformer for combustion which drives the catalysed endothermic reforming reaction occurring in the catalyst-containing reformer tubes. The hydrocarbon fuel is converted to carbon dioxide which is ultimately vented to the atmosphere. The use, in the present invention, of a portion of the crude hydrogen stream and/or the purified hydrogen stream as fuel for the fired reformer means that amount of carbon dioxide vented from the shell-side of the fired reformer can be reduced or eliminated.

In a second aspect the invention relates to a process of producing hydrogen using a plant according to the first aspect.

While it is envisaged that hydrogen plants according to the present invention may be built from scratch, it is an additional advantage that existing hydrogen plants having a fired reformer, water-gas shift unit and hydrogen purification unit can be retrofitted by introducing an autothermal reformer, a carbon dioxide removal unit, and associated piping necessary to feed hydrogen produced through the process as fuel to a shell-side of the fired reformer. Thus, the carbon capture of existing hydrogen plants can be improved. Therefore, in a third aspect the invention relates to a method of retrofitting an existing hydrogen plant, said existing hydrogen plant comprising:
a fired reformer containing a plurality of catalyst-containing reformer tubes and having a shell side to which fuel is fed, operable to produce a crude synthesis gas;
a water-gas shift unit arranged to be fed with a crude synthesis gas recovered from the fired reformer, operable to produce a hydrogen-enriched gas;
a purification unit arranged to be fed with a hydrogen-enriched gas from the water-gas shift unit, operable to produce a hydrogen product stream and an off-gas stream;
the method comprising the steps of:
installing an autothermal reformer downstream from the fired reformer and upstream from the water-gas shift unit, arranged to be fed with an oxygen-containing gas and crude synthesis gas from the fired reformer, operable to produce a reformed synthesis gas;
installing a carbon dioxide removal unit downstream from the water-gas shift unit and upstream from the purification unit, operable to produce a crude hydrogen stream and a carbon dioxide stream,
providing means for feeding a crude hydrogen stream from the carbon dioxide removal unit to the purification unit;
providing means for feeding a portion of the crude hydrogen stream from the carbon dioxide removal unit and/or a portion of the hydrogen product stream from the purification unit as fuel to the shell-side of the fired reformer.

### DETAILED DESCRIPTION OF THE INVENTION

Any sub-headings are provided for convenience only and are not intended to limit the disclosure.

### Fired Reformer

A fired reformer typically comprises a plurality of externally heated catalyst filled tubes. The tubes are filled with a steam reforming catalyst which is active to convert a feed of hydrocarbon and steam into a crude synthesis gas mixture comprising hydrogen, methane, carbon monoxide, carbon dioxide and steam. The tubes are heated on a shell side by a hot gas, which is provided by burning a fuel, normally a mixture of off-gas from a purification unit (e.g. a pressure swing adsorption unit) supplement by a portion of the hydrocarbon feed (e.g. methane).

As used herein, the term “feed” refers to the material which is provided to the catalyst-filled tubes in the fired reformer. This is generally a mixture of a hydrocarbon and steam. The term “fuel” is used to refer to the material which is provided to the shell-side of the fired reformer and which is burnt to provide heat for the endothermic steam reforming reaction.

The hydrocarbon feed may comprise any gaseous or low boiling hydrocarbon, such as natural gas, associated gas, LPG, petroleum distillate, diesel, naphtha or mixtures thereof, or hydrocarbon-containing off-gases from chemical processes, such as a refinery off-gas or a pre-reformed gas. The gaseous mixture preferably comprises methane, associated gas or natural gas containing a substantial proportion, e.g. over 50% by volume methane. Natural gas is especially preferred. The hydrocarbon may be compressed to a pressure in the range 10-100 bar abs. The pressure of the hydrocarbon may usefully govern the pressure throughout the process. Operating pressure is preferably in the range 15-50 bar abs, more preferably 25-50 bar abs as this provides an enhanced performance from the process.

If required, a hydrocarbon purification unit may be present upstream from the fired reformer. The role of the hydrocarbon purification unit is to remove impurities, such as sulphur compounds, chloride compounds and heavy metals, from the feed. The purification unit may include sorbents and/or hydrodesulphurisation catalysts and/or ultrapurification adsorbents. Suitable sorbents and catalysts are described in WO2022/003313A1 (Johnson Matthey), the contents of which are incorporated herein by reference in their entirety.

The hydrocarbon is mixed with steam. Steam introduction may be effected by direct injection of steam and/or by saturation of the feedstock by contact of the latter with a stream of heated water.

In the present invention, the steam ratio may be in the range of 1.5 to 3.5 moles of steam per mole of hydrocarbon carbon (that is, excluding carbon oxides), such as 1.6 to 3.5 or 1.6 to 3.0.
For the avoidance of doubt, in a mixture having a molar ratio of H₂O:CH₄:C₂H₆:CO:CO₂ of 6:1:1:1:1, methane and ethane provide the hydrocarbon carbon and the steam:hydrocarbon ratio is 6:3 (=2:1).

The mixture of hydrocarbon and steam, or the pre-reformed gas mixture, is subjected to steam reforming by passing the gas mixture through a plurality of externally heated catalyst filled tubes in a fired steam reformer to generate a crude synthesis gas mixture comprising hydrogen, methane, carbon monoxide, carbon dioxide and steam. Any hydrocarbons containing two or more carbon atoms that are present in the feed are converted to methane, carbon monoxide and hydrogen, and in addition, the reversible water-gas shift reactions occur.

Steam reforming reactions take place in the tubes over the steam reforming catalyst at temperatures above 350° C. and typically the process fluid exiting the tubes is at a temperature in the range 650 to 950° C. The heat exchange medium flowing around the outside of the tubes in the fired steam reformer may have a temperature in the range 900 to 1300° C.

Suitable steam reforming catalysts will be known to those skilled in the art. For instance, the steam reforming catalyst may be 10-30% wt nickel (expressed as NiO) supported on a refractory support such as calcium aluminate cement, alumina, titania, magnesia, zirconia and the like. Alkali (e.g. potash)-promoted catalysts are desirable where there is a risk of carbon formation. The catalyst is typically supplied as supported NiO, which is reduced in-situ prior to operation. Alternatively, particularly when a low steam ratio is employed, a precious metal catalyst may be used. Suitable precious metal catalysts include rhodium, ruthenium and platinum between 0.01 and 2% by weight on a suitable refractory support such as those used for nickel catalysts. Alternatively, a combination of a nickel and precious metal catalyst may be used. The steam reforming catalyst is normally in the form of shaped units, e.g. cylinders, rings, saddles, and cylinders having a plurality of through holes. Preferably the catalyst is in the form of lobed or fluted cylinders having a passage, or preferably more than one passage, extending longitudinally there-through, as this has been found to offer high catalyst activity combined with low pressure drop through the tubes. Alternatively, at least a portion of the steam reforming catalyst may include one or more structured catalyst units in the form of a ceramic or metal structure through which the reactants may flow in ordered, non-random directions, wash-coated with a layer of nickel and/or precious metal steam reforming catalyst. The invention therefore includes the option of replacing at least a portion of the existing steam reforming catalyst in the fired steam reformer with a structured steam reforming catalyst. Preferred structured steam reforming catalysts are described in US2012/0195801 A1 (Catacel Corporation).

The fired steam reformer may be a conventional fired steam reformer in which the reformer tubes are arranged vertically and are heated by a combusting fuel. The steam reformer may be a top-fired steam reformer or a side-fired steam reformer. In such fired reformers the hot gas used to heat the tubes is provided by combusting a fuel gas using a plurality of burners disposed either adjacent the top end or along the length of the tubes. In top-fired or side-fired reformers, the burners are conventionally fed with a fuel gas mixture comprising a hydrocarbon, such as methane, or other suitable fuel gases. Combustion is performed using an oxidant such as air, which is also fed to the one or more burners to form the hot combustion gas. In the case of a top-fired reformer the inlets for the feed gas mixture are typically located at the top end of the reformer and the outlets for the reformed gas mixture at the bottom end. The burners are located at the top end and the combusted gas outlet is typically located at the bottom end. In the case of a side-fired reformer the inlets for the feed gas mixture are typically located at the top end of the reformer and the outlets for the reformed gas mixture at the bottom end. The burners in this case are located at multiple levels between the top end and the bottom end and the combusted gas outlet is typically located at the top end. The feed gas mixture may be passed to distribution means, such as header pipes which distribute the feed gas mixture to the tubes. Collector pipes may be connected to the bottom of the tubes, which provide channels for collection of the reformed gas.

Conventionally the fired reformer hydrocarbon fuel gas comprises >50% by volume of methane. In the present invention, a portion of the crude hydrogen stream and/or the purified hydrogen stream is fed to a shell side of the fired reformer. Accordingly, the fuel combusted to heat the tubes in the fired steam reformed is hydrogen rich, i.e., the fuel gas is preferably >75% by volume H₂, more preferably ≥90% by volume H₂, most preferably ≥95% by volume H₂. The hydrogen fuel may be either provided from a portion of the crude hydrogen stream recovered from the carbon dioxide removal unit or a portion of the purified hydrogen product recovered from the hydrogen purification unit, or it may be a mixture of these. Whereas the CO₂ emissions by combustion are minimised by using only a portion of the purified hydrogen product stream, the use of pure hydrogen requires adjustment or potentially replacement of burners in the fired steam reformer and the heat energy generated by the combustion of hydrogen is different to that from conventional methane-rich fuel gases, which requires adjustment of the fuel and air flows. Moreover, increasing the production of the crude hydrogen product stream potentially requires increasing the capacity in the purification unit. Therefore, there are advantages by using a portion of the crude hydrogen product stream as a fuel for the fired steam reformer.

Combusting a portion of the hydrogen product gas would normally be seen as counter-intuitive, except that in the present invention, the uplift in capacity achieved by the installation of the autothermal reformer enables the existing hydrogen production unit to satisfy the hydrogen demand from existing downstream processes and at the same time significantly reduce the CO₂ emissions. The autothermal reformer is therefore desirably sized to provide essentially all of the hydrogen used as fuel in the fired steam reformer.

Fired steam reformers typically include one or more heat exchange coils for heating feeds and/or generating steam located in a flue gas-heated convection section of the reformer downstream of the zone in which the reformer tubes are located. The present invention should not require significant adjustment or re-configuration of these, but because the heat of combustion of hydrogen is different from conventional methane-based fuel gas, some adjustment of these may be desirable.

Adaptation of the burners in the fired steam reformer to use the hydrogen product as fuel may be required and may be accomplished in line with the manufacturer's instructions.

In addition to the adaptation of the fuel to the fired steam reformer, where one or more fired heaters are also used, e.g. to pre-heat feeds or generate steam for the process, the fuel for these may also be converted to include a portion of the crude hydrogen stream from the carbon dioxide removal unit and/or a portion of the purified hydrogen stream from the hydrogen purification unit.

A pre-reformer may be present upstream of the fired steam reformer. If a pre-reformer is present, then the hydrocarbon steam mixture may be fed to the inlet of a pre-reformer in which it is subjected to a step of adiabatic low temperature reforming. In such a process, the hydrocarbon/steam mixture is heated, typically to a temperature in the range 400-650° C., and then passed adiabatically through a bed of a suitable catalyst, usually a catalyst having a high nickel content, for example above 40% by weight. During such an adiabatic low temperature reforming step any hydrocarbons higher than methane react with steam to give a pre-reformed gas mixture of methane, steam, carbon oxides and hydrogen. The use of such an adiabatic reforming step, commonly termed pre-reforming, is desirable to ensure that the feed to the steam reformer contains no hydrocarbons higher than methane and also contains some hydrogen. This is desirable in order to minimise the risk of carbon formation on the catalyst in the steam reformer. If a pre-reformer is installed the steam ratio at the inlet to the steam methane reformer may be lowered e.g. to about 1.5 to 2.5 moles of steam per mole of hydrocarbon carbon, e.g. 2.0 to 2.5, such as 1.8 to 2.5 or 1.8 to 2.0. This has advantages in respect of providing lower operating costs, for example in steam generation. Hence the present invention may include lowering the steam to carbon ratio where a pre-reformer is installed.

The inclusion of an autothermal reformer downstream from the fired reformer in the present invention, as detailed below, means that reforming does not need to be as complete at the outlet of the fired reformer. Therefore, the throughput of hydrocarbon and steam provided to the fired reformer can be increased compared to a process operated without an autothermal reformer.

### Autothermal Reformer

In the present invention, an autothermal reformer is used to produce a reformed synthesis gas by reacting the crude synthesis gas from the fired reformer with an oxygen-containing gas.

In some embodiments additional steam is added to the crude synthesis gas upstream of the autothermal reformer. This allows greater control of the steam to carbon ratio of the feed to the autothermal reformer.

In some embodiments an additional hydrocarbon-containing gas may be added to the crude synthesis gas upstream of the autothermal reformer. For instance, the feed stream to the fired reformer may be split, a first portion sent to the fired reformer and a second portion added to the crude synthesis gas upstream of the autothermal reformer. This allows greater control of the steam to carbon ratio of the feed to the autothermal reformer.

The oxygen-containing gas fed to the autothermal reformer may be air or an oxygen-enriched gas such as oxygen-enriched air. While air is advantageous from a cost perspective, the use of air as the oxygen-containing gas means that the reformed synthesis gas fed to the water-gas shift unit and downstream units contains nitrogen which needs to be removed downstream. It is therefore preferred that the oxygen-containing gas is an oxygen-enriched gas, preferably comprising at least 50 vol % O₂, preferably at least 90 vol % O₂ such as at least 95 vol % O₂ or least 98 vol % O₂. The oxygen-enriched gas may be obtained using a vacuum pressure swing adsorption (VPSA) unit or an air separation unit (ASU). The ASU may be electrically driven and is desirably driven using renewable electricity to further improve the efficiency of the process and minimise CO₂ emissions. In some embodiments steam may be added to the oxygen-containing gas before being fed to the autothermal reformer.

The construction and arrangement of an autothermal reformer will be known to the skilled person and is described, for instance, in WO2022/003313 (Johnson Matthey). The autothermal reformer may comprise a burner disposed at the top of the reformer, to which the crude synthesis gas and the oxygen-rich gas are fed, a combustion zone beneath the burner through which a flame extends, and a fixed bed of particulate steam reforming catalyst disposed below the combustion zone. In autothermal reforming, the heat for the endothermic steam reforming reactions is therefore provided by combustion of a portion of hydrocarbon in the pre-reformed feed gas. The pre-reformed gas is typically fed to the top of the reformer and the oxygen-rich gas fed to the burner, mixing and combustion occur downstream of the burner generating a heated gas mixture the composition of which is brought to equilibrium as it passes through the steam reforming catalyst. The autothermal steam reforming catalyst may comprise nickel supported on a refractory support such as rings or pellets of calcium aluminate, magnesium aluminate, alumina, titania, zirconia and the like. In a preferred embodiment, the autothermal steam reforming catalyst comprises a layer of a catalyst comprising Ni and/or Ru on zirconia over a bed of a Ni on alumina catalyst to reduce catalyst support volatilisation that can result in deterioration in performance of the autothermal reformer. The output of the autothermal reformer is a reformed synthesis gas.

It may be desirable to adjust the temperature of the partially cooled reformed synthesis gas mixture upstream of the water gas shift unit. This may conveniently be done by raising steam and/or heating process feeds.

The high temperatures in the autothermal reformer means that the residual methane in the exit from the autothermal reformer is lower than in the case where only a fired reformer is present. A methane content as low as possible at the exit of the fired reformer is desirable because (i) the conversion to CO and/or CO₂ should be as high as possible to maximise H₂ yield; and (ii) there are generally no opportunities to convert CH₄ downstream from the fired reformer, meaning that CH₄ will be present in the off-gas which is either vented to the atmosphere or burnt. Venting CH₄ to the atmosphere is undesirable because it is a greenhouse gas. The increased hydrogen production afforded by the autothermal reformer installation in the present invention is able to fuel the fired steam reformer and so dramatically reduce the CO₂ emissions.

The increased temperature of the reformed synthesis gas produced by the autothermal reformer, compared to the temperature of the crude synthesis gas produced by the gas-fired reformer, also improves the energy efficiency of the process by allowing more efficient heat usage. In preferred embodiments, the reformed synthesis gas stream from the autothermal reformer is used to produce high pressure steam. This may be achieved by installing a heat exchanger between the outlet of the autothermal reformer and the water-gas shift unit. The high-pressure steam generated may be used elsewhere in the process, which in turn may eliminate the requirement for fired heaters to generate steam or pre-heat feeds. Where an existing plant is retrofitted with an ATR, an additional or replacement waste heat boiler may be installed to take advantage of the additional heat available from the installation of the ATR.

### Water-Gas Shift Unit

The reformed synthesis gas from the autothermal reactor is fed to a water-gas shift unit. The role of water-gas shift unit is to generate a shifted gas mixture which is enriched in hydrogen by the water-gas shift reaction (2):

CO+H₂O↔CO₂+H₂ (2)

The water-gas shift unit typically includes one or more beds of water-gas shift catalyst in one or more shift vessels to generate a shifted synthesis gas mixture enriched in hydrogen. At the same time the water gas shift unit converts carbon monoxide in the synthesis gas to carbon dioxide.

Because steam reforming is performed with an excess of steam it is generally not necessary to add steam to the reformed synthesis gas mixture recovered from the autothermal reformer to ensure sufficient steam is available for the water-gas shift reaction. However, supplemental steam may be added if desired.

The reformed gas exiting the autothermal reformer is at high temperature and it is preferred that the water-gas shift unit comprises a high-temperature shift stage. High-temperature shift may be operated adiabatically in a shift vessel at inlet temperatures in the range 300-400° C., preferably 320-360° C., over a bed of catalyst, such as a reduced iron catalyst, such as chromia-promoted magnetite. Alternatively, a promoted zinc-aluminate catalyst may be used.

In a conventional hydrogen plant it is not normally problematic if some CH₄ and/or CO remains at the outlet of the water-gas shift unit, because these gases can be collected as an off-gas stream and used as fuel in the fired reformer. As noted above, this leads to CO₂ generation which is released to the atmosphere. However, in the present invention where the fired reformer is fed predominantly on H₂, it is desirable for as much CH₄ as possible to be converted in the reforming unit and as much CO as possible to be converted in the WGS unit. Water-gas shift is an exothermic process and is therefore ideally carried out at low temperatures, but not so low as to risk condensation of water on the catalyst.

Where an existing hydrogen plant is retrofitted, it may be necessary to expand the capacity of the water-gas shift unit to manage the increased throughput achieved by the presence of the autothermal reformer, and to enhance the hydrogen productivity increased provided by installation of the autothermal reformer. In order to maximise conversion, in the present invention it is preferred that the water-gas shift unit comprises a high temperature shift stage followed by one or more medium- and/or low temperature shift stages. One or more medium- and/or low temperature shift stages may be present. The catalysts used in each stage may be the same or different and the skilled person will be aware of suitable catalysts for each stage. Therefore, the method may include the step of increasing the capacity of the water-gas shift unit. For example, by installing one or more medium- or low-temperature shift stage downstream from an existing high-temperature shift stage.

Medium-temperature shift and low-temperature shift stages may be performed using shift stages containing supported copper-catalysts, particularly copper/zinc oxide/alumina compositions. In medium-temperature shift, the gas containing carbon monoxide and steam may be fed to the catalyst at an inlet temperature in the range 200 to 240° C. although the inlet temperature may be as high as 280° C. The outlet temperature may be up to 300° C. but may be as high as 360° C.

In low-temperature shift, a gas containing carbon monoxide (preferably ≤6% vol CO on a dry basis) and steam (at a steam to total dry gas molar ratio in range 0.3 to 1.5) may be passed over the catalyst in an adiabatic fixed bed with an outlet temperature in the range 200 to 300° C. The outlet carbon monoxide content may be in the range 0.1 to 1.5%, especially under 0.5% vol on a dry basis if additional steam is added.

Where an existing hydrogen plant is retrofitted, the method may include the step of converting one or more of the existing water-gas shift stages from axial flow to axial-radial or radial flow, for example as described in WO2015/107322A1. This change reduces the burden on the compressor, compared to installing additional water-gas shift units. This change may be made instead of, or in addition to, expanding the capacity of the water-gas shift unit by installing one or more medium- or low-temperature shift stages.

Whereas one or more adiabatic water-gas shift stages may be employed, such as a high-temperature shift stage, optionally followed by one or more low-temperature shift stages, the partially cooled synthesis gas may be subjected to a stage of isothermal water-gas shift in a cooled shift vessel, optionally followed by one or more adiabatic medium- or low-temperature water-gas shift stages in un-cooled vessels as described above. The invention therefore may include replacing an adiabatic high temperature shift vessel (e.g. containing an iron catalyst) in the existing water gas shift unit with a cooled isothermal water gas shift vessel (e.g. containing a copper catalyst). Using an isothermal shift stage, i.e. with heat exchange in the shift converter such that the exothermic reaction in the catalyst bed occurs in contact with heat exchange surfaces that remove heat, offers the potential to use the reformed gas stream in a very efficient manner. Whereas the term “isothermal” is used to describe a cooled shift converter, there may be a small increase in temperature of the gas between inlet and outlet, so that the temperature of the hydrogen-enriched reformed gas stream at the exit of the isothermal shift converter may be between 1° C. and 25° C. higher than the inlet temperature. The coolant conveniently may be water under pressure such that partial, or complete, boiling takes place. The water can be in tubes surrounded by catalyst or vice versa. The resulting steam can be used, for example, to drive a turbine, e.g. for electrical power, or to provide process steam for supply to the process. In some embodiments, steam generated by the isothermal shift stage may be used to supplement the steam addition to the gaseous mixture comprising a hydrocarbon and steam upstream of the fired reformer. This improves the efficiency of the process and enables the relatively high steam to carbon ratio to be achieved at low cost.

### Treatment of Hydrogen Enriched Gas

Following the water-gas shift stage, the hydrogen-enriched gas is preferably cooled to a temperature below the dew point so that the steam condenses. The liquid water condensate may then be separated using one or more gas-liquid separators, which may have one or more further cooling stages between them. Any coolant may be used. Typically cooling of the hydrogen-enriched gas may be provided by boiling water under pressure coupled to a steam drum. If desired, cooling may be carried out in heat exchange with the process condensate. As a result, a stream of heated water, which may be used to supply some or all of the steam required for reforming, may be formed. Because the condensate may contain ammonia, methanol, hydrogen cyanide and CO₂, returning the condensate to form steam used in the reforming stage offers a useful way of returning hydrogen and carbon to the process.

One or more further stages of cooling are desirable. The cooling may be performed in heat exchange in one or more stages using demineralised water, air, or a combination of these. In a preferred embodiment, cooling is performed in heat exchange with one or more liquids in the CO₂ separation unit. One, two or three stages of condensate separation may be performed. Any condensate not used to generate steam may be sent to water treatment as effluent.

### Carbon Dioxide Removal Unit

In the present invention, after separation of the condensed water, carbon dioxide is separated from the resulting de-watered hydrogen-enriched gas stream in a carbon dioxide purification unit.

The role of the carbon dioxide removal unit is to separate the hydrogen-enriched stream into a carbon dioxide stream and a crude hydrogen stream. Typically, the hydrogen-enriched gas stream contains 10 to 30% vol of carbon dioxide (on a dry basis). A wide range of carbon dioxide removal technologies may be used in the present invention.

In one embodiment the carbon dioxide removal unit operates by means of a physical wash system or a reactive wash system, preferably a reactive wash system. An amine wash system is a particularly preferred option.

In one embodiment the carbon dioxide removal unit operates by an acid gas recovery (AGR) process. In the AGR process, the de-watered hydrogen-enriched reformed gas stream (i.e. the de-watered shifted gas) is contacted with a stream of a suitable absorbent liquid, such as an amine, for example monoethanolamine, diethanolamine, methyl diethanolamine and diglycolamine, particularly methyl diethanolamine (MDEA) solution so that the carbon dioxide is absorbed by the liquid to give a laden absorbent liquid and a gas stream having a decreased content of carbon dioxide. The laden absorbent liquid is then regenerated by heating, to desorb the carbon dioxide and to give a regenerated absorbent liquid, which is then recycled to the carbon dioxide absorption stage. The heating may suitably be provided by steam, hot condensate or another suitable heating medium generated by the process. Alternatively, methanol or a glycol may be used to capture the carbon dioxide in a similar manner as the amine. If the carbon dioxide separation step is operated as a single pressure process, i.e. essentially the same pressure is employed in the absorption and regeneration steps, only a little recompression of the recycled carbon dioxide will be required. Carbon dioxide removal units of the types described above are commercially available.

The recovered carbon dioxide is relatively pure and so may be compressed and used for the manufacture of chemicals, purified for use in the food industry or greenhouse applications, or sent to storage or sequestration or used in enhanced oil recovery (EOR) processes.

Compression may be accomplished using an electrically driven compressor powered by renewable electricity. In cases where the CO₂ is to be compressed for storage, transportation, use in EOR processes or conversion to other chemical products, the CO₂ may be first dried to prevent liquid water present in trace amounts, from condensing. For example, the CO₂ may be dried to a dew point ≤−10° C. by passing it through a bed of a suitable desiccant, such as a zeolite, or contacting it with a glycol in a glycol drying unit.

Upon the separation of the carbon dioxide, the process provides a crude hydrogen gas stream. The crude hydrogen stream may comprise 75-99% vol hydrogen, preferably 90-99% vol hydrogen, with the balance comprising one or more of methane, carbon monoxide, carbon dioxide and inert gases. The methane content of the crude hydrogen stream may be in the range 0.25-7.5% vol. The carbon monoxide content of the crude hydrogen stream may be in the range 0.5-7.5% vol. The carbon dioxide content of the crude hydrogen stream may be in the range 0.01-2.5% vol.

A portion of the crude hydrogen stream may be provided as fuel to the gas-fired reformer, with the remainder being fed to the hydrogen purification unit.

By installing a carbon dioxide removal unit, the invention provides means for removing carbon dioxide from the hydrogen-enriched gas in a relatively pure form for use in the production of chemicals or for carbon capture and storage. This also reduces the carbon dioxide content in the off-gas stream from the purification unit to very low levels such that it is more suitable for addition to the hydrocarbon feed to the steam reformer. Where the off-gas stream is used as feed to the reformers rather than as a fuel, CO₂ emissions from the existing hydrogen production unit may be virtually eliminated.

### Hydrogen Purification Unit

The carbon dioxide purification unit produces a crude hydrogen gas stream. Whereas this hydrogen gas stream may be pure enough for many duties, in the present invention, the crude hydrogen gas stream is passed to a purification unit to provide a purified hydrogen product stream and an off-gas stream.

The role of the hydrogen purification unit is to separate the crude hydrogen stream into a purified hydrogen stream and an off-gas stream. A wide range of hydrogen purification technologies may be used in the present invention.

In one embodiment the hydrogen purification unit comprises a membrane system, a temperature swing adsorption system, or a pressure swing adsorption system. The purification unit is preferably a pressure-swing adsorption unit. Such units comprise regenerable porous adsorbent materials that selectively trap gases other than hydrogen and thereby purify it. The purification unit produces a pure hydrogen stream preferably with a purity greater than 99.5% vol, more preferably greater than 99.9% vol. Such systems are commercially available. The purification unit also produces an off-gas.

In the present invention, because carbon dioxide is removed by the carbon dioxide removal unit it may not be necessary to enlarge or adjust the operation of the purification unit. However, if desired, additional purification units may be installed in parallel to the existing purification unit, and/or the operating method for the existing purification unit may be adjusted to account for the reduction in carbon dioxide.

The hydrogen purification unit desirably operates with continual separation of the off-gas from the crude hydrogen stream. The off-gas composition depends on the extent of the purification of the crude hydrogen stream. For example, the off-gas stream may comprise 30-90% vol hydrogen, with the balance comprising one or more of methane, carbon monoxide, carbon dioxide and potentially inert gases. The off-gas stream will typically comprise methane, which may be present as unreformed hydrocarbon in the feed or from conversion of longer chain hydrocarbons in the feed to methane. The methane content of the off-gas may be in the range 2 to 10%, preferably 2 to 8% vol. The carbon monoxide content of the off-gas may be in the range 5-30% vol, preferably 5 to 25% vol. The carbon dioxide content of the off-gas may be in the range 0-10% vol, preferably 0-2.5% vol.

The invention therefore may include installing means for dividing the purified hydrogen stream into a first portion, which is returned to the fired reformer as a fuel gas, and a second portion, which is used in downstream processes. In the present invention preferably essentially all of the additional crude and/or purified hydrogen is used as fuel in the fired reformer. Whereas this may reduce the overall production from the hydrogen production unit, the significant lowering of CO₂ emissions provided by the invention remains very attractive.

The second portion of the purified hydrogen stream may be compressed and used in the existing downstream processes. The second portion of the pure hydrogen may be used in a downstream chemical synthesis process. For example, the second portion of the pure hydrogen stream may be used in a refinery for hydrotreating or hydrocracking processes. Alternatively, the second portion may be used to produce ammonia by reaction with nitrogen in an ammonia synthesis unit. Alternatively, the second portion of the pure hydrogen may be used with a carbon dioxide-containing gas to manufacture methanol in a methanol production unit. Alternatively, the second portion of the pure hydrogen may be used with a carbon-monoxide containing gas to synthesise hydrocarbons in a Fischer-Tropsch production unit. Any known ammonia, methanol or Fischer-Tropsch production technology may be used. Alternatively, the purified hydrogen product may be used in downstream power or heating process, e.g. by using it as fuel in a gas turbine (GT) or by injection into a domestic or industrial networked gas piping system. Compression of the purified hydrogen stream for any of the above uses may suitably be accomplished using an electrically driven compressor powered by renewable electricity.

If desired, a portion of the crude hydrogen or a portion of the second portion of the pure hydrogen may be compressed if necessary and recycled to the hydrocarbon feed for hydrodesulphurisation and to reduce the potential for carbon formation on the catalyst in the fired reformer and autothermal reformer.

In some embodiments a portion of the off-gas from the hydrogen purification unit is combusted as fuel in the fired steam reformer in accordance with conventional practice. However, this will result in CO₂ emissions, therefore in such cases, the proportion of the off-gas used as fuel is preferably ≤10% by volume, more preferably ≤55% by volume, most preferably ≤1% by volume, of the off-gas. Accordingly, in preferred embodiments, at least a portion of the off-gas is returned to the process by adding it to the hydrocarbon feed, or the hydrocarbon and steam mixture fed to the fired reformer. This ensures that as much carbon as possible is converted to CO₂ for capture. In this embodiment it may be necessary to first remove inerts (such as N₂) before returning the off-gas stream to the fired reformer feed stream, in order to prevent inerts from building up in the process. This may be achieved by including an offgas recovery unit downstream from the purification unit, to separate the off-gas stream from the hydrogen purification unit into a hydrocarbon stream and an off-gas stream.

### Retrofitting a Hydrogen Plant

A hydrogen plant according to the present invention may be prepared by retrofitting an existing hydrogen plant containing in series: a fired steam reformer containing a plurality of catalyst-containing reformer tubes, a water-gas shift unit, and a purification unit. An autothermal reformer is installed between the fired steam reformer and the water gas-shift unit; a carbon dioxide removal unit is installed between the water-gas shift unit and the purification unit; and means are provided for feeding a portion of the crude hydrogen stream from the carbon dioxide removal unit and/or a portion of the hydrogen product stream from the purification unit as fuel to the shell-side of the fired reformer.

The invention will be further illustrated by reference to the Figures.

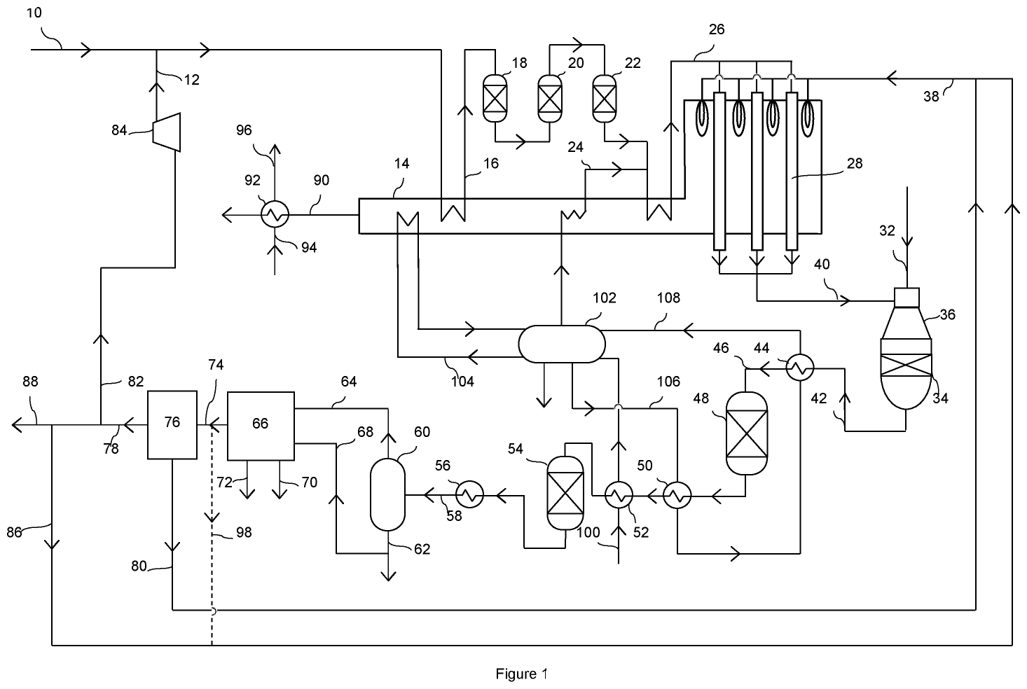

FIG. 1 is a flow sheet depicting a hydrogen production unit according to one embodiment of the invention comprising a fired steam reformer and an installed autothermal reformer and carbon dioxide removal unit, with hydrogen product supplied as fuel for the fired steam reformer;

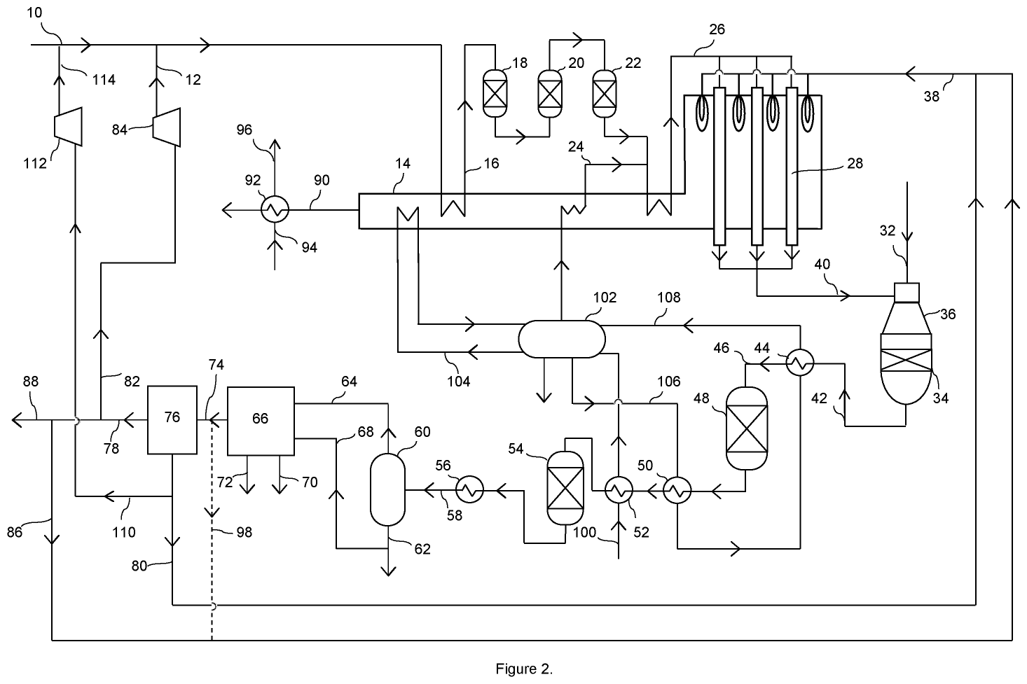

FIG. 2 is a flow sheet depicting a hydrogen production unit according to another embodiment of the invention comprising a fired steam reformer and an installed autothermal reformer and carbon dioxide removal unit, with hydrogen product supplied as fuel for the fired steam reformer, and with off-gas from the purification unit supplied to the hydrocarbon feed; and

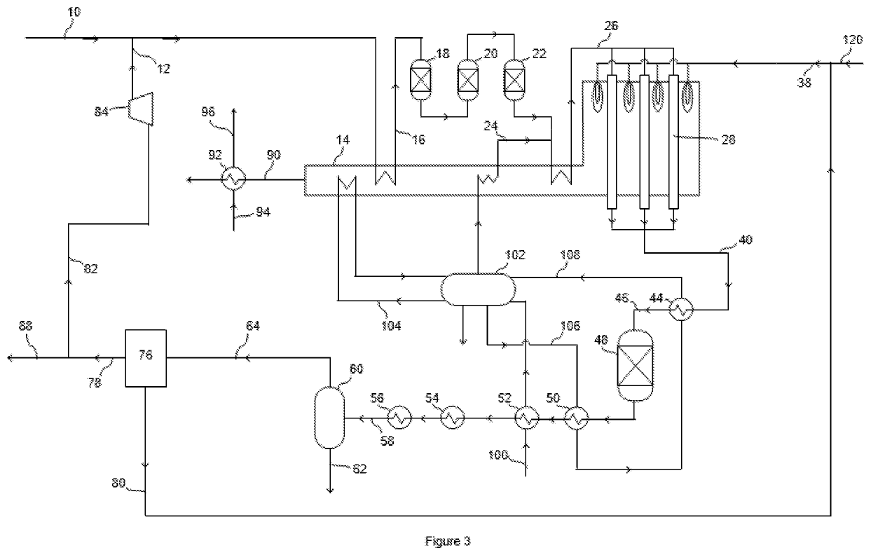

FIG. 3 is a comparative embodiment depicting a conventional hydrogen production unit comprising a fired steam reformer without a carbon dioxide removal unit or autothermal reformer.

It will be understood by those skilled in the art that the drawings are diagrammatic and that further items of equipment such as reflux drums, pumps, vacuum pumps, temperature sensors, pressure sensors, pressure relief valves, control valves, flow controllers, level controllers, holding tanks, storage tanks, and the like may be required in a commercial plant. The provision of such ancillary items of equipment forms no part of the present invention and is in accordance with conventional chemical engineering practice.

In FIG. 1 a natural gas stream 10 is combined with a small amount of a compressed hydrogen stream 12 and the resulting mixture heated in the convection section of a fired steam reformer 14. The resulting heated gas mixture 16 is passed through a first purification vessel 18 containing a fixed bed of hydrodesulphurisation catalyst in which hydrogen in the feed is reacted with organic sulphur compounds therein to convert them to hydrogen sulphide. The resulting gas mixture is then passed through a second purification vessel 20 and a third purification vessel 22, each containing a bed of a hydrogen sulphide adsorbent that removes the sulphur compounds to form a desulphurised natural gas stream. The desulphurised natural gas stream recovered from vessel 22 is combined with superheated steam provided via line 24, and the resulting mixture of desulphurised natural gas and steam is heated in the convection section of the fired steam reformer 14. The resulting pre-heated desulphurised natural gas and steam mixture is fed via line 26 to inlets of a plurality of externally heated catalyst-filled reformer tubes 28 in the fired steam reformer 14. The plurality of catalyst-filled reformer tubes 28 in the fired steam reformer 14 are heated by combusting a fuel gas fed via line 38 in a radiant section of the fired reformer, located upstream of the convection section. Steam reforming reactions occur in the catalyst-filled reformer tubes 28. A first crude synthesis gas 40 is recovered from outlets of the plurality of fired reformer tubes 28 and fed to the autothermal reformer 36 along with an oxygen-containing gas 32 and reacted over a catalyst 34 to form a reformed synthesis gas 42. The reformed synthesis gas is fed via line 42, to a heat exchanger 44 where it is cooled and the resulting combined synthesis gas fed via line 46 to the inlet of a high-temperature shift vessel 48 containing a fixed bed of high temperature shift catalyst. The water-gas shift reactions occur over the high-temperature shift catalyst, forming a hydrogen enriched gas. The hydrogen enriched gas is recovered from the water gas shift vessel 48 and cooled in heat exchange with medium-pressure steam in heat exchanger 50, then boiler feed water in heat exchanger 52. The hydrogen enriched gas is then fed to a low-temperature shift vessel 54 containing a fixed bed of low temperature shift catalyst. The water-gas shift reactions occur over the low-temperature shift catalyst, forming a hydrogen enriched gas. The resulting gas is cooled in heat exchange 56 to cool the hydrogen-enriched gas to below the dew point such that a condensate is formed. The resulting mixture is fed from heat exchanger 56 via line 58 to a gas-liquid separator 60. The condensate is recovered from the gas-liquid separator 60 via line 62. The resulting de-watered hydrogen-enriched gas is fed via line 64 to a carbon dioxide removal unit 66 that uses an amine wash solution to recover carbon dioxide from the de-watered hydrogen-enriched gas. The carbon dioxide removal unit 66 uses a portion 68 of the condensate to heat and desorb carbon dioxide from the amine wash solution in a regeneration unit within the carbon dioxide removal unit. Water is recovered from the carbon dioxide removal unit 66 via line 70 and may be used for steam generation within the process. A carbon dioxide stream is recovered from the carbon dioxide removal unit 66 via line 72. The carbon dioxide stream 72 may be dried, purified and compressed for storage or for the synthesis of useful products (not shown). A crude hydrogen product is recovered from the carbon dioxide removal unit 66 and fed via line 74 to a purification unit 76 comprising a pressure-swing absorption vessel containing a sorbent. The pressure-swing absorption vessel produces a purified hydrogen product, which is recovered from the purification unit 76 via line 78. The purification unit also provides an off-gas stream, which is fed via line 80 to form part of the fuel gas stream 38 combusted in the fired steam reformer 14. A portion of the purified hydrogen product may be fed from line 78 via line 82 to compressor 84 where it is compressed to provide the hydrogen stream 12 added to the natural gas feed 10. A further portion of the purified hydrogen product is fed via line 86 to form the remainder of the fuel gas stream 38 combusted in the fired steam reformer 14. A remaining portion of the purified hydrogen product is exported via line 88 for use downstream.

Flue gas from the fired steam reformer 14 is recovered from the convection section via line 90 and cooled in heat exchanger 92 before being vented to atmosphere. Heat exchanger 92 is used to heat combustion air 94, which is fed from heat exchanger 92 via line 96 to combust the fuel gas in stream 38 in the radiant section of the fired steam reformer.

It will be understood that while this embodiment uses a portion of the purified hydrogen stream 78 via line 86 as a fuel in the fired steam reformer 14, it is possible to use a portion of the crude hydrogen product from line 74 as a fuel. This is depicted as dashed line 98.

Boiler feed water 100 is heated in heat exchanger 52 and passed to a steam drum 102 that provides steam for the process. The steam drum 102 has a steam boiler circuit 104 heated by the flue gas in the convection section of the fired steam reformer 14. The steam drum 102 also provides a hot water stream 106 used to cool the hydrogen-enriched gas in heat exchanger 50 and the crude synthesis gas in heat exchanger 44 before being returned to the steam drum 102 via line 108.

In FIG. 2, the process is as depicted in FIG. 1, except that a portion of the off-gas stream 80 is taken via line 110, compressed in compressor 112 and added via line 114 to the natural gas feed in line 10.

In FIG. 3, the process is as depicted in FIG. 1, but the autothermal reformer 36 and carbon dioxide removal unit 66 are not present. All of the hydrocarbon and steam mixture 26 is fed to the plurality of tubes 28 in the fired steam reformer 14 and the crude synthesis gas stream 40 from the fired steam reformer 14 is directed to the heat exchanger 44 and the water gas shift vessel 48. In this arrangement, a portion of the hydrogen product stream 78 is not used as fuel for the fired steam reformer and accordingly all of the off gas from the purification unit 76 is directed via line 80 to the fired steam reformer as fuel. The off gas in line 80 is supplemented by the combustion of a natural gas fuel fed via line 120 in order to provide the heat for the steam reforming reaction.

### EXAMPLES

The invention is further illustrated by reference to the following calculated Examples.

The processes of FIGS. 1, 2 and 3 may be compared in terms of fuel demand and CO₂ efficiency. The results were as follows:

| | | | | | | | CO₂ |
|---|---|---|---|---|---|---|---|
| | | | | | | | emission |
| | | | | | | | reduction |
| | | NG | H₂ | NG | CO₂ | CO₂ | per unit |
| | | Feed | Product | Fuel | Captured | Released | H₂² |
| Case | Figure | (Nm³/h) | (Nm³/h) | (Nm³/h) | (tonne/h) | (tonne/h) | (%) |
| No CO₂ removal | 3 | 44860 | 135000 | 10770 | 0 | 116 | 0 |
| ¹CO₂ removal, ATR | 1 | 55070 | 135000 | 0 | 105.00 | 10 | 91.3 |
| (O₂), H₂ recycle to | | | | | | | |
| fuel, LTS | | | | | | | |
| ¹CO₂ removal, ATR | 1 | 57690 | 137000 | 0 | 109.60 | 11 | 91.0 |
| (air), H₂ recycle to | | | | | | | |
| fuel, LTS | | | | | | | |
| CO₂ removal, ATR | 2 | 55730 | 134600 | 0 | 115.20 | 1 | 98.9 |
| (O₂), H₂ recycle to | | | | | | | |
| fuel, LTS, PSA offgas | | | | | | | |
| recycle to feed | | | | | | | |

¹without PSA offgas recycle to feed
²Relative to the no CO₂ removal case

The process of FIGS. 1 and 2 were modelled based on a natural gas feed and fuel to illustrate the achievable reductions in CO₂ emissions. A comparative example based on FIG. 3, was also modelled. The results for FIG. 2 were as follows:

| | | Stream Number | | | | | |
|---|---|---|---|---|---|---|---|
| | | 10 | | | 26 | 40 | 32 |
| | | Natural | 12 | 24 | Feed | Crude | Oxygen- |
| | | gas | Compressed | Superheated | to steam | synthesis | containing |
| | | stream | H₂ recycle | steam | reformer | gas | gas |
| Temperature | ° C. | 40 | 111 | 411 | 550 | 790 | 246 |
| Pressure | bar a | 28.5 | 30.0 | 26.3 | 24.8 | 21.7 | 33.7 |
| Mass Flow | tonne/h | 42.5 | 0.1 | 102.4 | 156.6 | 156.6 | 20.6 |
| Vapour Flow | Nm³/h | 55730 | 1600 | 127300 | 198200 | 271800 | 15000 |
| Molecular Weight | | 17.0 | 2.0 | 18.0 | 17.7 | 12.9 | 30.9 |
| Composition | mol % | | | | | | |
| Water | | — | — | 100.00 | 64.58 | 27.86 | 8.29 |
| Hydrogen | | — | 100.00 | — | 2.22 | 46.59 | — |
| CO | | — | — | — | 2.21 | 9.43 | — |
| CO₂ | | 0.50 | — | — | 0.17 | 5.84 | — |
| Nitrogen | | — | — | — | — | — | — |
| Argon | | — | — | — | 0.53 | 0.39 | 0.46 |
| Methane | | 95.00 | — | — | 29.03 | 9.89 | — |
| Ethane | | 3.00 | — | — | 0.84 | — | — |
| Propane | | 1.00 | — | — | 0.28 | — | — |
| Butane | | 0.50 | — | — | 0.14 | — | — |
| Oxygen | | — | — | — | — | — | 91.25 |
| Heavies | | — | — | — | — | — | — |

| | | Stream Number | | | | | | |
|---|---|---|---|---|---|---|---|---|
| | | 42 | 64 | 74 | | 86 | 80 | 114 |
| | | Reformed | De-watered | Crude | 78 | H₂ | Offgas | Compressed |
| | | synthesis | hydrogen | hydrogen | Hydrogen | fuel to | fuel to | offgas |
| | | gas | enriched gas | product | product | reformer | reformer | to feed |
| Temperature | ° C. | 923 | 65 | 40 | 40 | 40 | 40 | 150 |
| Pressure | bar a | 21.0 | 17.9 | 17.8 | 17.5 | 17.5 | 1.7 | 28.5 |
| Mass Flow | tonne/h | 177.2 | 148.9 | 30.82 | 12.10 | 6.06 | 0.97 | 11.56 |
| Vapour Flow | Nm³/h | 317100 | 281900 | 219600 | 134600 | 67440 | 2400 | 13570 |
| Molecular Weight | | 12.53 | 11.84 | 3.15 | 2.02 | 2.02 | 8.81 | 19.09 |
| Composition | mol % | | | | | | | |
| Water | | 25.82 | 1.49 | 0.33 | — | — | 2.00 | 5.01 |
| Hydrogen | | 52.26 | 73.85 | 94.75 | 100.00 | 100.00 | 68.40 | 20.62 |
| CO | | 14.86 | 1.66 | 2.13 | — | — | 12.82 | 32.22 |
| CO₂ | | 5.16 | 20.85 | 0.03 | — | — | 0.19 | 0.49 |
| Nitrogen | | — | — | — | — | — | — | — |
| Argon | | 0.35 | 0.40 | 0.51 | — | — | 3.08 | 7.74 |
| Methane | | 1.55 | 1.75 | 2.24 | — | — | 13.50 | 33.92 |
| Ethane | | — | — | — | — | — | — | — |
| Propane | | — | — | — | — | — | — | — |
| Butane | | — | — | — | — | — | — | — |
| Oxygen | | — | — | — | — | — | — | — |
| Heavies | | — | — | — | — | — | — | — |

1. A plant for the production of hydrogen, comprising:
a fired reformer containing a plurality of catalyst-containing reformer tubes and having a shell side to which fuel is fed, operable to produce a crude synthesis gas from a feed stream containing a hydrocarbon and steam;
an autothermal reformer arranged to be fed with an oxygen-containing gas and a crude synthesis gas from the fired reformer, operable to produce a reformed synthesis gas;
a water-gas shift unit arranged to be fed with a reformed synthesis gas recovered from the autothermal reformer, operable to produce a hydrogen-enriched gas;
a carbon dioxide removal unit arranged to be fed with a hydrogen-enriched gas from the water-gas shift unit, operable to produce a crude hydrogen stream and a carbon dioxide stream; and
a purification unit arranged to be fed with a crude hydrogen stream gas from the carbon dioxide removal unit, operable to produce a hydrogen product stream and an off-gas stream,
wherein the plant is arranged such that a portion of the crude hydrogen stream from the carbon dioxide removal unit and/or a portion of hydrogen product stream from the purification unit is fed as fuel to a shell-side of the fired reformer.

2. The plant according to claim 1, wherein the water-gas shift unit comprises a high-temperature shift stage followed by one or more medium-temperature shift stages and/or one or more low-temperature shift stages.

3. The plant according to claim 1, wherein the carbon dioxide removal unit operates by means of a physical wash system or a reactive wash system.

4. The plant according to claim 1, wherein the carbon dioxide removal unit operates by means of an amine wash system.

5. The plant according to claim 1, wherein the purification unit operates by pressure swing adsorption and/or temperature swing adsorption.

6. The plant according to claim 1, wherein the plant is arranged such that at least a portion of the off-gas stream is fed to the fired reformer feed stream.

7. The plant according to claim 1, wherein the plant is arranged such that the reformed synthesis gas from the autothermal reformer is used to produce high-pressure steam.

8. A process for the production of hydrogen, comprising the steps of:
feeding a mixture of hydrocarbon and steam to a fired reformer containing a plurality of catalyst-containing reformer tubes to produce a crude synthesis gas;
feeding a fuel to the shell-side of the fired reformer to provide heat for the steam reforming reactions taking place in the catalyst-containing reformer tubes;
feeding the crude synthesis gas from the fired reformer to an autothermal reformer along with an oxygen-containing gas to produce a reformed synthesis gas;
feeding the reformed synthesis gas to a water-gas shift unit to produce a hydrogen-enriched gas;
feeding the hydrogen-enriched gas to a carbon dioxide removal unit and separating the hydrogen-enriched gas into a crude hydrogen stream and a carbon dioxide stream;
feeding the crude hydrogen stream to a purification unit and separating the crude hydrogen stream into a hydrogen product stream and an off-gas stream; and
feeding a portion of the crude hydrogen stream and/or a portion of hydrogen product stream as fuel to the shell-side of the fired reformer.

9. The process according to claim 8, wherein the process is carried out in a plant for the production of hydrogen, comprising:
a fired reformer containing a plurality of catalyst-containing reformer tubes and having a shell side to which fuel is fed, operable to produce a crude synthesis gas from a feed stream containing a hydrocarbon and steam;
an autothermal reformer arranged to be fed with an oxygen-containing gas and a crude synthesis gas from the fired reformer, operable to produce a reformed synthesis gas;
a water-gas shift unit arranged to be fed with a reformed synthesis gas recovered from the autothermal reformer, operable to produce a hydrogen-enriched gas;
a carbon dioxide removal unit arranged to be fed with a hydrogen-enriched gas from the water-gas shift unit, operable to produce a crude hydrogen stream and a carbon dioxide stream; and
a purification unit arranged to be fed with a crude hydrogen stream gas from the carbon dioxide removal unit, operable to produce a hydrogen product stream and an off-gas stream,
wherein the plant is arranged such that a portion of the crude hydrogen stream from the carbon dioxide removal unit and/or a portion of hydrogen product stream from the purification unit is fed as a fuel to a shell-side of the fired reformer.

10. The process according to claim 8, wherein the hydrocarbon in the mixture of hydrocarbon and steam comprises natural gas, associated gas, LPG, petroleum distillate, diesel, naphtha or mixtures thereof, a refinery off-gas, or a pre-reformed gas.

11. The process according to claim 8, wherein the hydrocarbon in the mixture of hydrocarbon and steam comprises natural gas.

12. The process according to claim 8, wherein the mixture of hydrocarbon and steam fed to the fired reformer has a ratio of 1.5 to 3.5 moles of steam per mole of hydrocarbon carbon.

13. The process according to claim 8, wherein the fuel to the shell-side of the fired reformer comprises at least 75% vol H2.

14. The process according to claim 8, wherein the fuel to the shell-side of the fired reformer comprises at least 95% vol H2.

15. The process according to claim 8, wherein the oxygen-containing gas is selected from air, oxygen-enriched air or oxygen.

16. The process according to claim 8, wherein the autothermal reformer is sized to provide essentially all of the hydrogen used as fuel in the fired reformer.

17. The process according to claim 8, wherein carbon dioxide recovered from the carbon dioxide removal unit is:
compressed and used for the manufacture of chemicals;
purified for use in the food industry or greenhouse applications;
sent to storage or sequestration; and/or
used in enhanced oil recovery processes.

18. The process according to claim 8, wherein the mixture of hydrocarbon and steam fed to the fired reformer includes at least a portion of the off-gas stream.

19. A method of retrofitting an existing hydrogen plant, said existing hydrogen plant comprising:
a fired reformer containing a plurality of catalyst-containing reformer tubes and having a shell side to which fuel is fed, operable to produce a crude synthesis gas;
a water-gas shift unit arranged to be fed with a crude synthesis gas recovered from the fired reformer, operable to produce a hydrogen-enriched gas; and
a purification unit arranged to be fed with a hydrogen-enriched gas from the water-gas shift unit, operable to produce a hydrogen product stream and an off-gas stream;
the method comprising the steps of:
installing an autothermal reformer downstream from the fired reformer and upstream from the water-gas shift unit, arranged to be fed with an oxygen-containing gas and a crude synthesis gas from the fired reformer, operable to produce a reformed synthesis gas;
installing a carbon dioxide removal unit downstream from the water-gas shift unit and upstream from the purification unit, arranged to be fed with a hydrogen-enriched gas from the water-gas shift unit, operable to produce a crude hydrogen stream and a carbon dioxide stream;
providing means for feeding a crude hydrogen stream from the carbon dioxide removal unit to the purification unit; and
providing means for feeding a portion of the crude hydrogen stream from the carbon dioxide removal unit and/or a portion of the hydrogen product stream from the purification unit as fuel to the shell-side of the fired reformer.

20. The method according to claim 19, wherein the resulting retrofitted hydrogen plant for the production of hydrogen, comprises:
a fired reformer containing a plurality of catalyst-containing reformer tubes and having a shell side to which fuel is fed, operable to produce a crude synthesis gas from a feed stream containing a hydrocarbon and steam;
an autothermal reformer arranged to be fed with an oxygen-containing gas and a crude synthesis gas from the fired reformer, operable to produce a reformed synthesis gas;
a water-gas shift unit arranged to be fed with a reformed synthesis has recovered from the autothermal reformer, operable to produce a hydrocarbon-enriched gas;
a carbon dioxide removal unit arranged to be fed with a hydrogen-enriched gas from the water-gas shift unit, operable to produce a crude hydrogen stream and a carbon dioxide stream; and
a purification unit arranged to be fed with a crude hydrogen stream gas from the carbon dioxide removal unit, operable to produce a hydrogen product stream and an off-gas stream,
wherein the plant is arranged such that a portion of the crude hydrogen stream from the carbon dioxide removal unit and/or a portion of hydrogen product stream from the purification unit is fed as fuel to a shell-side of the fired reformer.

21. The method according to claim 19, wherein the method includes the step of installing a heat exchanger between the outlet of the autothermal reformer and the water-gas shift unit.

22. The method according to claim 19, wherein the method includes the step of installing a replacement or additional waste heat boiler.

23. The method according to claim 19, wherein the method includes the step of expanding the capacity of the water-gas shift unit.

24. The method according to claim 19, wherein the method includes the step of installing one or more medium- or low-temperature shift stages downstream from an existing high-temperature shift stage.

25. The method according to claim 19, wherein the method includes the step of converting an existing water-gas shift stage from axial flow to axial-radial or radial flow.
